(19) United States
(12) Patent Application Publication
(10) Pub. No.: US 2011/0301830 A1
(43) Pub. Date: Dec. 8, 2011

(54) GEOMETRICALLY CONSTRAINING A TRAVEL ROUTE USING A NAVIGATION SYSTEM

(75) Inventor: Edward D. Tate, JR., Grand Blanc, MI (US)

(73) Assignee: GM GLOBAL TECHNOLOGY OPERATIONS, INC., Detroit, MI (US)

(21) Appl. No.: 12/794,159

(22) Filed: Jun. 4, 2010

(51) Int. Cl. G01C 21/00

(52) U.S. Cl. 701/200

(57) ABSTRACT

A navigation system for use with a geospatial database includes a presentation device and a host machine in communication with the database. The host machine executes an algorithm to calculate a geometrically-constrained auxiliary travel route between a route origin and a route destination using mapping data from the geospatial database and a reference geometric path, wherein the auxiliary travel route is geometrically-constrained by minimizing a cost of deviating from the reference geometric path. The host machine then presents information describing the auxiliary travel route using the presentation device. The geometric path may be one of a straight line, an arc, and a set of road segments having a predetermined geometric feature. The cost of deviating includes at least one of a distance of deviating from the reference geometric path, and a number of crossings or switchbacks of the auxiliary travel route with respect to the reference geometric path.

### TECHNICAL FIELD

The present invention relates to a method and system for calculating and displaying travel route information using a navigation system.

### BACKGROUND

Navigation systems include networked computer devices which accurately determine a position of a user using global positioning data. The position is then presented to the user via a geocoded map. Turn-by-turn directions may be presented to a particular destination from the user's position or another recorded position. Map data including topographical and road network information is typically communicated to a host machine, e.g., a vehicle navigation system, cell phone, personal digital assistant, or a web server, which then processes and presents the information via a graphical display, text-based driving directions, and/or speech-based driving directions.

Using geospatial data, the host machine can provide precise directions to any location contained in a referenced database. Directions may be tailored to a user's preference using a criterion such as shortest driving distance, fastest travel route, or easiest/least complicated travel route. Additionally, emerging hybrid or extended-range electric vehicle designs may allow users to select a most economical route or “eco-route”, i.e., a recommended travel route that minimizes fossil fuel consumption by directing the user to travel routes that would tend to extend the electrical operating range of the vehicle relative to other possible routes.

### SUMMARY

A navigation system and method are disclosed herein which geometrically constrain a recommended or reference travel route using a cost function. The function considers a cost of deviating from a reference geometric path, e.g., an arc, a straight line, or another preferred geometric feature set, such that the auxiliary travel route that is ultimately presented is constrained to some extent by the reference geometric path. The present method may be encoded as a computational algorithm executed by a host machine, with the geometrically-constrained auxiliary travel route presented to the user graphically on a display screen as a map trace and/or as text-based driving directions, and/or as a broadcast of audible turn-by-turn driving directions.

Under certain circumstances a recommended travel route presented to a user may remain less than optimal in a geometric sense. For example, conventional navigation algorithms may recommend a travel route having a potentially undesirable geometric trait such as frequent route crossovers or switchbacks, where a driver is instructed to cross back and forth over a primary road multiple times in a zig-zag pattern. Such traits may be presented when a user selects calculation and presentation of an eco-route, although fastest, shortest, or easiest routes may occasionally contain similar geometric traits. Depending on the degree of deviation from a geometrically desirable reference path, users may be inclined to disregard at least some of these recommended travel routes.

Accordingly, a navigation system is disclosed herein for use with a geospatial database, whether aboard a vehicle or otherwise. The navigation system includes a presentation device and a host machine in communication with the geospatial database. The host machine determines a reference travel route between a route origin and a route destination using mapping data from the geospatial database, and calculates a geometrically-constrained auxiliary travel route as a function of a cost of deviating from a reference geometric path. The host machine then presents information describing the auxiliary travel route using the presentation device.

The reference geometric path may be one of a straight line, an arc, and a set of road segments having a predetermined geometric feature. The cost of deviating may include at least one of a distance of deviating from the reference geometric path, and a number of crossings or switchbacks of the reference travel route(s) with respect to the reference geometric path.

A method of operating the navigation system described above includes using the host machine to calculate a geometrically-constrained auxiliary travel route using mapping data from the geospatial database and a reference geometric path, wherein the auxiliary travel route is geometrically-constrained with respect to one or more reference travel paths using a cost function of deviating from the reference geometric path. The method also includes presenting information describing the auxiliary travel route using the presentation device.

The method may include assigning costs to different segments of the reference travel route(s) as a function of at least one of: a distance of deviating from the reference geometric path and a number of crossings or switchbacks of the reference geometric path by the various reference travel routes.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a navigation system as disclosed herein;

FIG. 2 is a schematic illustration of a pair of possible travel routes as presented via the navigation system of FIG. 1;

FIG. 3 is a schematic illustration of another pair of possible travel routes as presented via the navigation system of FIG. 1; and

FIG. 4 is a flow chart describing an algorithm usable with the navigation system of FIG. 1.

### DESCRIPTION

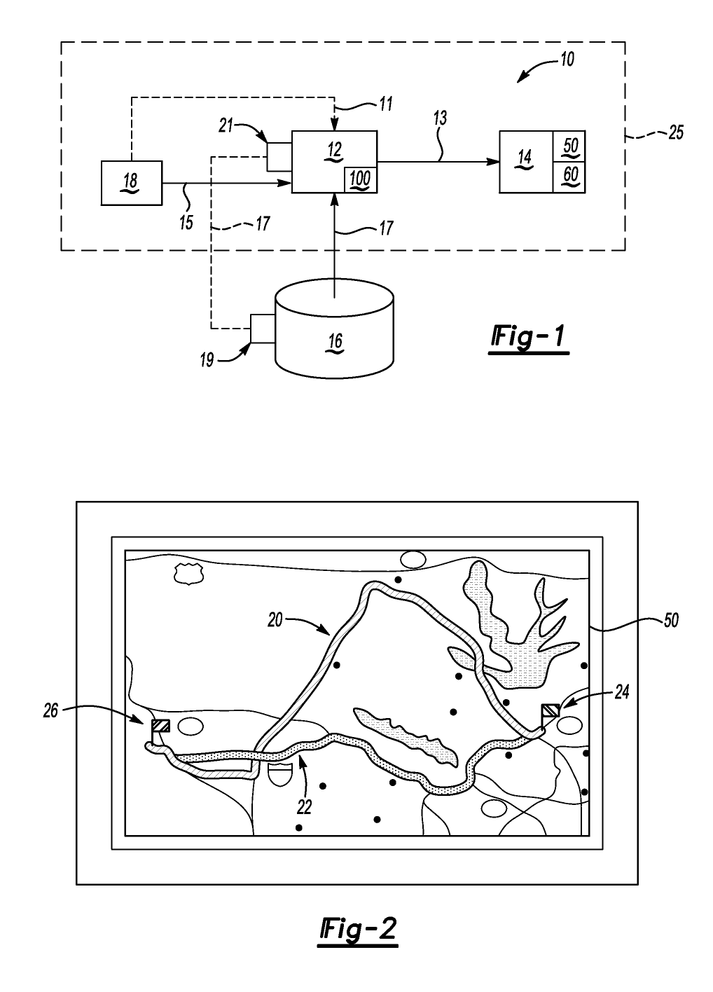

Referring to the drawings wherein like reference numbers correspond to like or similar components throughout the several figures, and beginning with FIG. 1, a navigation system 10 includes an algorithm 100 for geometrically constraining a travel route using a reference geometric path as explained below. Navigation system 10 includes a host machine 12, a presentation device 14, and an input device 18 for sending input data 15 to the host machine. In one embodiment, the navigation system 10 is adapted for use in a vehicle 25, wherein the host machine 12, the presentation device 14, and the input device 18 are positioned within the vehicle. Regardless of the embodiment, the host machine 12 is in remote or local network communication with a geospatial database 16.

As used herein, the term “geospatial database” refers to a geographic information system containing geospatial data 17 of multiple contiguous locations. Geospatial database 16 may be remotely located with respect to the navigation system 10 as shown, with the geospatial data 17 being accessible by the host machine 12 using an optional transmitter/receiver pair 19, 21. When geospatial database 16 is local, e.g., stored on mapping software accessed directly by the host machine 12, the database is positioned aboard the vehicle 25, and therefore the transmitter/receiver pair 19, 21 may be omitted.

Alternatively, input device 18 and/or host machine 12 may be portions of a mobile unit, e.g., a portable electronic device such as a touch screen, personal digital assistant (PDA), cell phone, or a laptop or tablet-style computer, depending on the configuration of the navigation system 10. While shown schematically as a single machine in FIG. 1 for simplicity, host machine 12 may be configured as multiple mobile devices, or it may be a distributed system accessing a web server. For example, when configured as a vehicle navigation system in just one possible embodiment, host machine 12 and the input device 18 may be networked together and to the geospatial database 16.

Presentation device 14 may be any audio/visual device capable of presenting a geographically-constrained auxiliary travel route 13 to a user. For example, presentation device 14 may include a display screen 50 for graphically or visually displaying a travel route using a graphical route/map trace and/or text-based driving directions, and/or an audio speaker 60 for broadcasting turn-by-turn driving directions as audible speech. Input data 15 may include route origin, route destination, and a user-selected criterion such as fastest route (in time), shortest route (in distance), easiest route (e.g., minimum number of turns or high-speed travel), and economically efficient/eco route (e.g., most fuel-efficient route). In one possible embodiment, presentation device 14 and input device 18 may be a common device, such as a touch-screen capable of detecting and recording the input data 15 by a touch of the user's hand or a stylus.

Host machine 12 selectively executes algorithm 100 to determine a reference travel route using input data 15, e.g., route origin, route destination, and the route criterion noted above, and using geospatial data 17 from the geospatial database 16. The algorithm 100 then calculates the geometrically-constrained auxiliary travel route 13 as a function of a predetermined geometric path 11, which may be selected by a user via the input device 18 in one embodiment, and presents information describing the auxiliary travel route to a user using the presentation device 14.

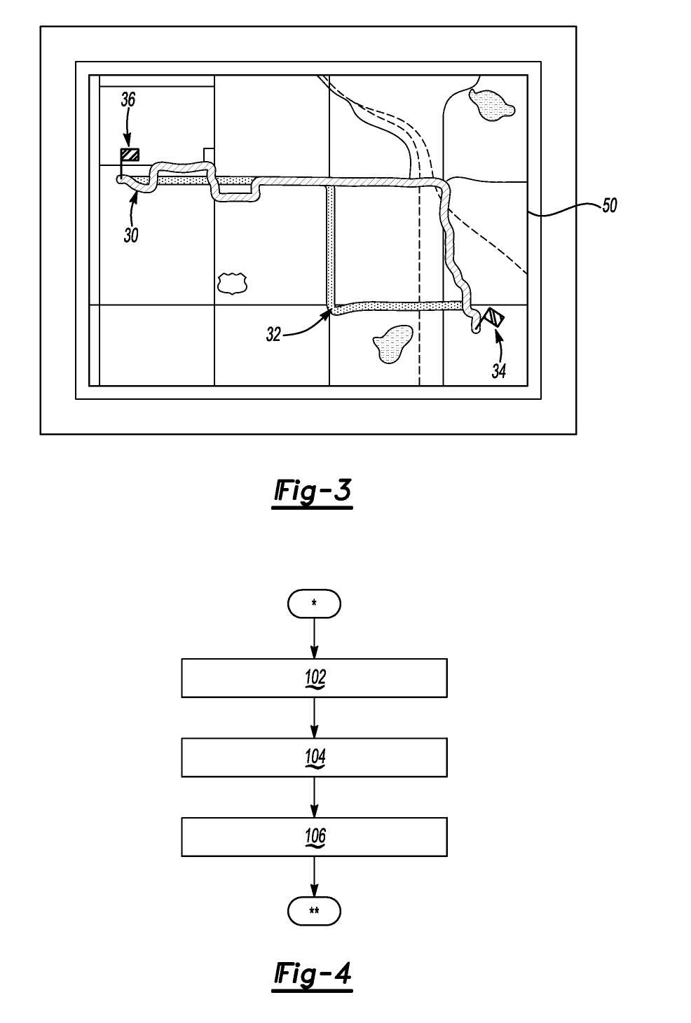

Referring to FIGS. 2 and 3, display screen 50 of the presentation device 14 shown in FIG. 1 displays reference travel routes 20 and 30 in FIGS. 2 and 3, respectively, and auxiliary travel routes 22 and 32, respectively, with the reference travel routes and auxiliary route sharing a route origin 24, 34 and a route destination 26, 36 in the embodiments shown. In the example shown in FIG. 2, reference travel route 20, which is calculated by the host machine 12 but not displayed unless and until it is determined to have the lowest calculated route cost as described below, has a potentially undesirable geometric trait in the form of an extreme way-around. That is, a user is directed far away from a minimum distance route between the route origin 24 and the route destination 26. If displayed, a user may be inclined to disregard reference travel route 20, even if it is the fastest, most economical, or easiest route.

Similarly, reference travel route 30 of FIG. 3 has a potentially undesirable geometric trait in the form of series of route crossovers or switchbacks, wherein the reference travel route repeatedly crosses back and forth in a zig-zag pattern. In FIGS. 2 and 3, respectively, the calculated auxiliary travel routes 22, 32 provide a travel route that is geometrically-constrained to some extent by the reference geometric path 11, e.g., a straight line, an arc, or a set of road segments having a desired geometric feature or feature set, with the latter of these shown in FIG. 3 and the arc/line embodiment shown in FIG. 2, with respect to their respective reference travel routes 20 and 30.

Referring to FIG. 4 in conjunction with the various components of the navigation system 10 shown in FIG. 1 and described above, algorithm 100 proceeds to step 102 upon initiating (*), e.g., when a user turns on the navigation system. At step 102, input data 15 may be recorded in the form of route origin, which may be determined via a global positioning system (GPS) (not shown), a route destination entered by the user, and a route criterion such as a fastest, shortest, easiest, or eco-route. The algorithm 100 proceeds to step 104 after this information is recorded.

At step 104, the host machine 12 references the geospatial database 16 to retrieve the required geospatial data 17, and then calculates one or more reference travel routes, e.g., routes 20 and 30 of FIGS. 2 and 3, respectively, using the geospatial data and, as needed, the input data 15 from step 102. For example, if at step 102 a user selects the fastest route as part of the route criteria, host machine 12 could calculate one or more reference travel routes requiring a minimum amount of travel time from origin to destination relative to other possible routes. The reference travel routes are not yet geometrically-constrained, and in one possible embodiment are not displayed to the user so as to simplify presentation of information. However, in other embodiments the reference travel routes may also be displayed, e.g., in a different shade or brightness, so as to present the alternative routes to the user. The algorithm 100 then proceeds to step 106.

At step 106, the host machine 12 next calculates the geometrically-constrained auxiliary travel route 13 shown in FIG. 1 using a cost function of the reference geometric path 11, and then presents information describing the auxiliary travel route using the presentation device 14. Step 106 may entail assigning costs to the different legs or segments of the reference geometric path 11 and/or the various reference travel routes to be constrained, for example as a function of distance between different segments of the reference travel route(s) and the reference geometric path and/or of the number of crossovers or switchbacks of the reference travel route(s) with respect to the reference geometric path 11.

For example, a cost formula may be applied to each segment of a reference travel route to determine a reference cost (c_{ref}) as follows:

c_{ref(start,end)}=k_{1·d(start,end)}+k_{2·t(start,end)}+k₁·E(start,end)+k_{4·d}_{ₘᵢₙ}(ref,start,end)+k5·X(ref,start,end)

Weights (k₁−k₅) may be assigned to different constraints, such as distance (d), time (t), and energy use (E). Additionally, geometric constraints can be weighted to generate routes that blend acceptable efficiency with a desired geometry and/or topographical or geographical feature. In the above formula, cost penalties may be assessed when a given reference travel route crosses the reference geometric path, an event indicated by (X), and/or proportionately higher costs may be assessed the farther one departs from the reference geometric path 11 as indicated by (dₘᵢₙ). Allowances may be made for obstacles, either in the cost function or in the designation of the reference geometric path 11. For example, a straight line may pass through a body of water or other topographical or geographical feature, requiring an arc or a more circuitous trace that still approximates the reference geometric path 11.

Using the navigation system 10 and algorithm 100 disclosed above, a geometrically-constrained auxiliary route 13 is presented that can satisfy desired route criteria without generating a travel route that may be perceived as being geometrically undesirable to a user. Although one reference travel route 20, 30 is shown for simplicity in each of FIGS. 2 and 3, collections of multiple different possible reference travel routes could also be generated with varying costs assigned to competing terms with respect to a baseline costing model, with a lowest cost route ultimately selected and presented as the geometrically-constrained auxiliary travel route 13. The result is a minimization of instances in which geometrically unappealing travel routes may be generated and presented to the user.

While the best modes for carrying out the invention have been described in detail, those familiar with the art to which this invention relates will recognize various alternative designs and embodiments for practicing the invention within the scope of the appended claims.

1. A navigation system for use with a geospatial database, the navigation system comprising:
a presentation device; and
a host machine in communication with the geospatial database, the host machine being operable for:
determining a reference travel route between a route origin and a route destination using mapping data from the geospatial database;
calculating a geometrically-constrained auxiliary travel route as a function of a cost of deviating from a reference geometric path, wherein the geometrically-constrained auxiliary travel route is a geometrically-constrained variant of the reference travel route; and
presenting information describing the auxiliary travel route using the presentation device.

2. The navigation system of claim 1, wherein the reference geometric path is one of a straight line, an arc, and a set of road segments having a predetermined geometric feature.

3. The navigation system of claim 1, wherein the cost of deviating includes at least one of a distance of deviating from the reference geometric path, and a number of crossings or switchbacks of the auxiliary travel route with respect to the reference geometric path.

4. The navigation system of claim 1, wherein the reference geometric path includes multiple reference geometric paths, and wherein the cost of deviating from each of the multiple reference geometric paths is used by the host machine to calculate the auxiliary travel route.

5. The navigation system of claim 1, wherein the presentation device includes at least one of a display screen and an audio speaker, and wherein the host machine presents the information describing the auxiliary route via at least one of the display screen and the audio speaker.

6. The navigation system of claim 1, wherein the auxiliary travel route is geometrically-constrained with respect to one of: a shortest route, a fastest route, an easiest route, and a most economically efficient route.

7. A navigation system for use in a vehicle, the navigation system comprising:
an audio/visual presentation device positioned within the vehicle; and
a host machine positioned within the vehicle, the host machine being in remote communication with a geospatial database;
wherein the host machine:
determines a reference travel route between a route origin and a route destination using mapping data from the geospatial database;
calculates a geometrically-constrained auxiliary travel route as a function of a cost of deviating from a reference geometric path, wherein the geometrically-constrained auxiliary travel route is a geometrically-constrained variant of the reference travel route; and
presents information describing the auxiliary travel route using the presentation device.

8. The navigation system of claim 7, wherein the host machine uses the function to assign costs to different segments of the auxiliary travel route with respect to at least one of a distance of deviating from the reference geometric path and a number of crossings or switchbacks of the reference travel route with respect to the reference geometric path.

9. The navigation system of claim 7, wherein the host machine segments the reference geometric path, and then assigns weights to different segments of the reference geometric path to account for topographical or geographical features contained in the geospatial database.

10. The navigation system of claim 7, wherein the host machine graphically displays the information describing the auxiliary travel route as at least one of a map trace and text-based driving directions.

11. The navigation system of claim 7, wherein the reference travel route is one of: a shortest route, a fastest route, an easiest route, and a most economically efficient route.

12. The navigation system of claim 7, wherein the reference geometric path is one of a straight line, an arc, and a set of road segments having a predetermined geometric feature.

13. A method of operating a navigation system having a display device and a host machine in communication with a geospatial database, the method comprising:
determining a reference travel route between a route origin and a route destination using mapping data from the geospatial database;
calculating a geometrically-constrained auxiliary travel route as a function of a cost of deviating from a reference geometric path, wherein the geometrically-constrained auxiliary travel route is a geometrically-constrained variant of the reference travel route; and
presenting information describing the auxiliary travel route using the presentation device.

14. The method of claim 13, wherein calculating a geometrically-constrained auxiliary travel route includes using a cost function that assigns costs to different segments of the auxiliary travel route as a function of at least one of: a distance of deviating from the reference geometric path and a number of crossings or switchbacks of the reference geometric path.

15. The method of claim 13, further comprising assigning different weights to different segments of the reference geometric path within the function.

16. The method of claim 13, wherein the reference geometric path is one of a straight line, an arc, and a set of road segments having a predetermined geometric feature.
